(19) United States
(12) Patent Application Publication
(10) Pub. No.: US 2006/0001206 A1
(43) Pub. Date: Jan. 5, 2006

(54) Elastic deformable cushion

(76) Inventor: Yang Teng Jen, Wufeng Shiang (TW)

Correspondence Address: CHARLES E. BAXLEY, ESQ., 90 JOHN STREET, THIRD FLOOR, NEW YORK, NY, 10038, US

(21) Appl. No.: 10/881,083

(22) Filed: Jul. 1, 2004

(51) Int. Cl. F16F 1/00

(52) U.S. Cl. 267/153; 267/145

(57) ABSTRACT

The present invention relates to an elastic deformable cushion, an elastoplastic knee of which is provided at the thrust surface with curved portion so as to improve the compressive rigidity. On the vertical thrust surface of the elastoplastic knee piece is provided with multi layers of arc-curved portion for improving the buffering effect. Furthermore, the elastoplastic knee and the elastoplastic knee piece are unnecessarily formed in the shape of a helical structure. In this case, the elastic deformable cushion in accordance with the present invention can be easily produced, the corresponding production cost will be reduced.

### BACKGROUND OF THE INVENTION

1. Field of the Invention

The present invention relates to an elastic deformable cushion, and more particularly to an elastic deformable cushion that is integrally formed by soft elastoplastic knee and hard elastoplastic knee piece, through this structure, the damper performance and elastic recovery function of the elastic deformable cushion is improved.

2. Description of the Prior Arts

Shock-absorbing structure is widely used, such as on the machine, the shoes and the article for daily use. TW Patent No. 91,218,489 discloses a conventional shock-absorbing structure (as shown in FIG. 1), which includes elastoplastic spiral member 10 and elastoplastic spiral strip 11. The elastoplastic spiral member 10 and the elastoplastic spiral strip 11 are installed in the sole of a sneaker. The connecting portion of the elastoplastic spiral member 10 and that of the elastoplastic spiral strip 11 can be integrally connected together. The elastoplastic spiral member 10 is formed in the shape of a spiral spring. The elastoplastic spiral strip 11 is formed with multi layers of arc-curved portions 12 corresponding to the elastoplastic spiral member 10, and each layer of the arc-curved portions 12 are helically connected to each other. The elastoplastic spiral strip 11 is fixed in the elastoplastic spiral member 10. However, this conventional elastic cushion still has some disadvantages as follows:

First, the elastoplastic spiral member 10 and the elastoplastic spiral strip 11 must be combined together and produced in a helical manner, however, the production cost of the helical manner is pretty high.

Second, the shape of the elastoplastic spiral member 10 and the elastoplastic spiral strip 11 has been confined to the helical cylinder, thereby, the applicability of the conventional elastic cushion is limited.

The present invention has arisen to mitigate and/or obviate the afore-described disadvantages.

### SUMMARY OF THE INVENTION

The primary object of the present invention is to provide an elastic deformable cushion, an elastoplastic knee of which is provided at the thrust surface with curved portion so as to improve the compressive rigidity. On the vertical thrust surface of the elastoplastic knee piece is provided with multi layers of arc-curved portion for improving the buffering effect.

The secondary object of the present invention is to provide an elastic deformable cushion, wherein the elastoplastic knee and the elastoplastic knee piece are unnecessarily formed in the shape of a helical structure. In this case, the elastic deformable cushion in accordance with the present invention can be easily produced, the corresponding production cost will be reduced.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a structural perspective view of a conventional elastic deformable cushion;

FIG. 2 is a horizontal cross sectional view of an elastic deformable cushion in accordance with a first embodiment of the present invention;

FIG. 3 is a vertical cross sectional view of an elastic deformable cushion in accordance with a first embodiment of the present invention;

FIG. 4 is an operational cross sectional view of an elastic deformable cushion in accordance with a first embodiment of the present invention, which shows the elastic deformable cushion is being compressed by a force;

FIG. 5 is a perspective view of an elastic deformable cushion in accordance with a first embodiment of the present invention;

FIG. 6 is an operational cross sectional view of an elastic deformable cushion in accordance with a first embodiment of the present invention;

FIG. 7 is a perspective cross sectional view of an elastic deformable cushion in accordance with a second embodiment of the present invention;

FIG. 8 is an operational cross sectional view of an elastic deformable cushion in accordance with a third embodiment of the present invention, which shows the elastic deformable cushion is being compressed by a force;

FIG. 9 is a side view of an elastic deformable cushion in accordance with a fourth embodiment of the present invention;

FIG. 10 is a side view of an elastic deformable cushion in accordance with a fifth embodiment of the present invention;

FIG. 11 is a perspective cross sectional view of an elastic deformable cushion in accordance with a fourth embodiment of the present invention;

FIG. 12 is a side view of an elastic deformable cushion in accordance with a sixth embodiment of the present invention;

FIG. 13 is an operational view of an elastic deformable cushion in accordance with an embodiment of the present invention;

FIG. 14 is a partial amplified view of an elastic deformable cushion in accordance with the present invention;

FIG. 15 is an operational view of an elastic deformable cushion in accordance with an embodiment of the present invention, wherein the elastoplastic knee piece is formed with holes;

FIG. 16 is another partial amplified view of an elastic deformable cushion in accordance with the present invention.

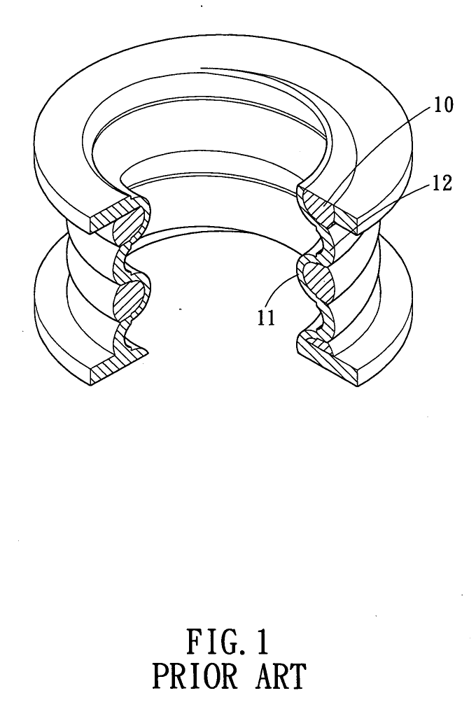

### DETAILED DESCRIPTION OF THE PREFERRED EMBODIMENTS

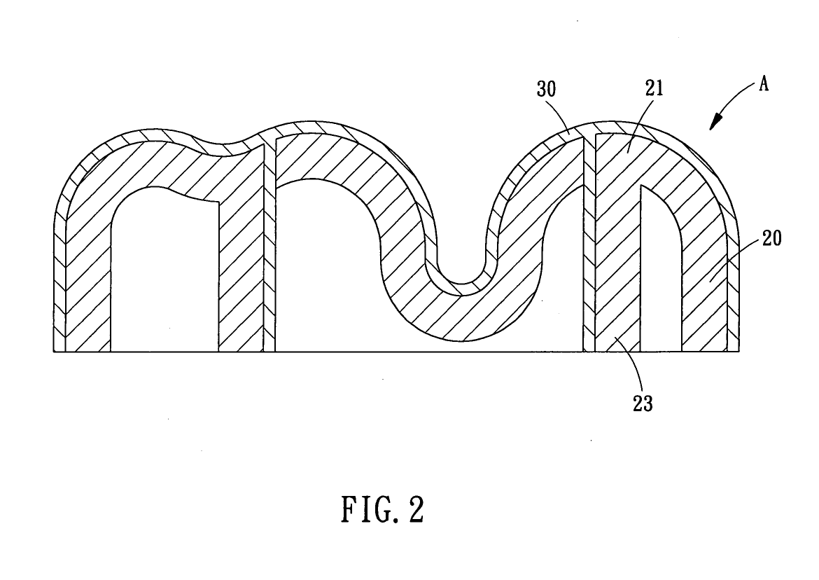

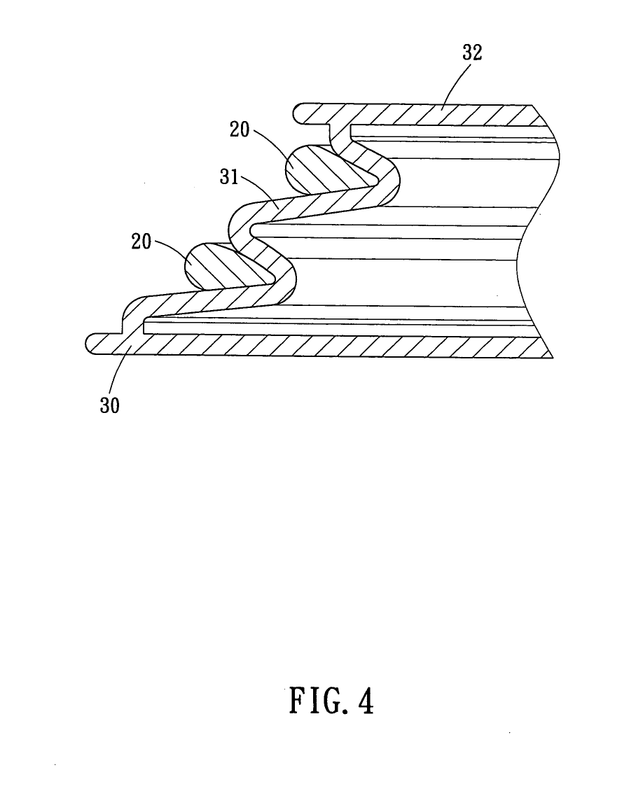

Referring to FIGS. 2-4, an elastic deformable cushion A is shown and generally including an elastoplastic knee 20 and an elastoplastic knee-piece 30, both of which are to be disposed on a thrust surface of a shock-absorb object (such as: sole and the buffering equipment). The elastic deformable cushion is made by plastic ejection molding (or reimplantation), in this case, the plastic connecting portion of the elastoplastic knee 20 and that of the elastoplastic knee-piece 30 will be integrally and firmly connected to each other.

The elastoplastic knee 20 is strip-shaped and made of soft elastoplastic material. The elastoplastic knee 20 is multi-layer constructed, and the respective layers of the elastoplastic knee 20 are alternatively arranged. The elastoplastic knee 20 is provided with plural curved portions 21 which are U-shaped corresponding to the thrust surface. Each of the plural curved portions 21 is provided with an outward protruded supporting portion 23. The respective layers of the elastoplastic knee 20 are separated from one another by a buffering distance 22.

The elastoplastic knee-piece 30 is a thin piece made of hard elastoplastic material, which is formed with plural layers of arc-curved portions 31 that correspond to the respective layers of the elastoplastic knee 20. The respective arc-curved portions 31 are continuously formed, a top surface 32 and a bottom surface 33 of the elastoplastic knee-piece 30 are formed as a thrust surface corresponding to the thrust direction. The elastoplastic knee-piece 30 is integrally connected to a side of the elastoplastic knee 20 (including the curved portions 21 and the supporting portions 23). The connecting portion of the arc-curved portions 31 are integrally formed with the surface of the elastoplastic knee 20, and the arc-curved portions 31 are formed in the buffering distance 22 between the respective layers of the elastoplastic knee 20.

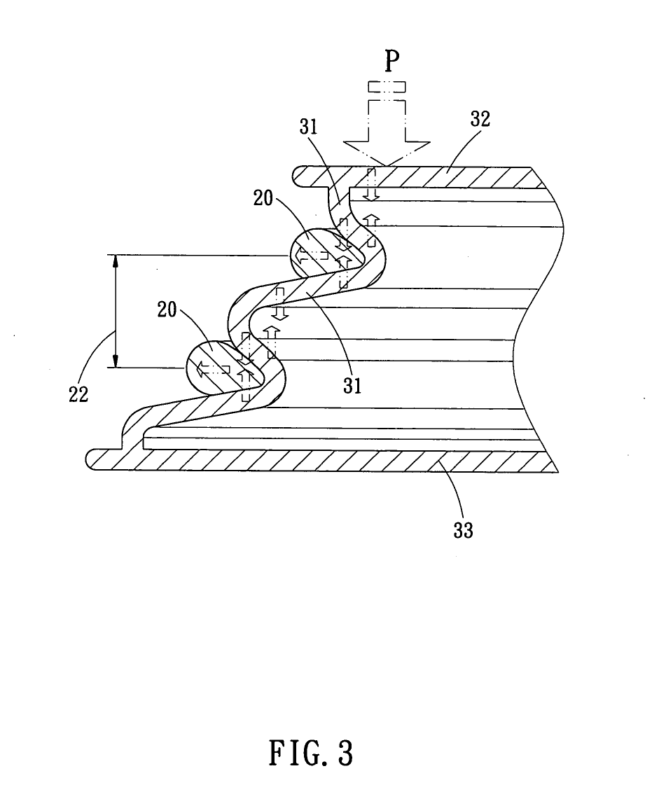

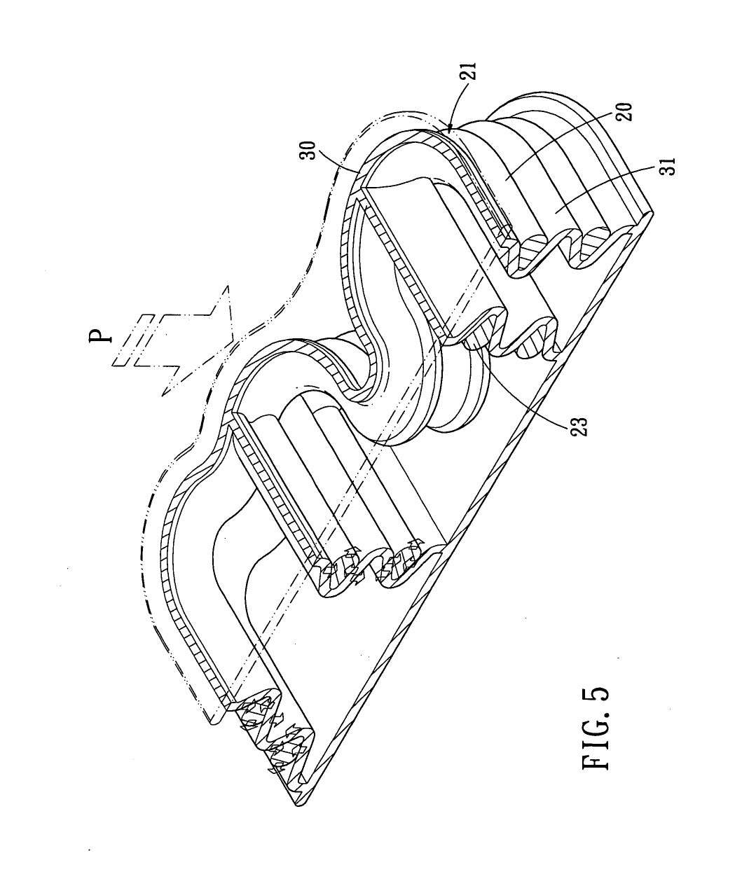

Referring to FIGS. 3 and 5, when the elastic deformable cushion A is compressed by an even pressure force P from the top surface, the top surface 32 of the elastoplastic knee-piece 30 synchronously bears the pressure force P, then the pressure force P is transmitted to the first layer of the elastoplastic knee-piece 30 and the top layer of the elastoplastic knee 20. The deformation capability of the top elastoplastic knee 20 and the buffering distance 22 can provide adequate deforming space (the first load-carrying compressive space) for the respective arc-curved portions 31 of the elastoplastic knee-piece 30. The rest layers, after the first layer, of the elastoplastic knee-piece 30 and that of elastoplastic knee 20 will repeat the operation as the first layer of the elastoplastic knee-piece 30 and the first elastoplastic knee 20 do, so as to produce adequate deforming space (more than two load-carrying compressive spaces). Thus, the respective load-carrying compressive spaces can disperse and absorb the pressure force P.

On the other hand, the plural curved portions 21 can be used to improve the compressive rigidity of the elastoplastic knee 20, and the curved portions 21 on the thrust surface and the supporting portions 23 are used to maintain the predetermined shape of the elastic deformable cushion A (to prevent the permanent deformation of the elastic deformable cushion A). At this moment, not only the raw material of the elastoplastic knee 20 and the elastoplastic knee-piece 30 can produce recovering elastic force, but also the curved portions 21 and the supporting portions 23 of the elastoplastic knee 20 can generate an inward pulling force. Moreover, the plural arc-curved portions 31 of the elastoplastic knee-piece 30 will produce a recovering force to counter the external thrust. Thereby, the present invention can produce multiple recovering forces to counter the deformation, through this way, the pressure force P is effectively absorbed. In addition, the elastoplastic knee 20 and the elastoplastic knee-piece 30 can be various shapes, therefore, the elastic cushion in accordance with the present invention has a wide applicability.

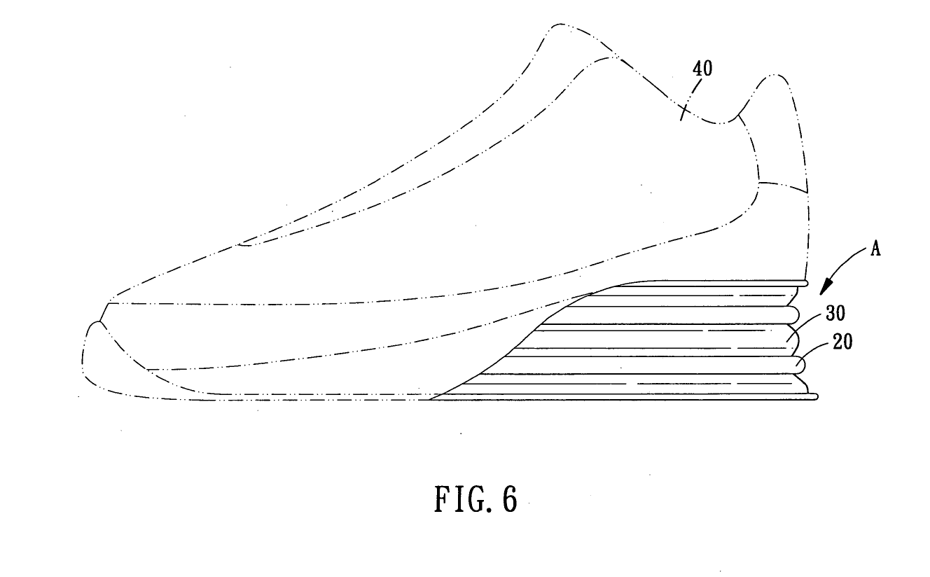

It will be noted that the elastoplastic knee 20 and the elastoplastic knee-piece 30 can produce a resistant force corresponding to an uneven pressure force P exerted on any side of the elastic deformable cushion (for example: the pressure force P is exerted on the right side, then a resistant force will be synchronously generated on the left side). Thereby, when the elastic deformable cushion is subject to a deflecting pressure force P, other portions of the elastic deformable cushion A in accordance with the present invention can synchronously produce a recovering force to balance the deflecting pressure force P. On the other hand, when an uneven pressure force is exerted on the elastic deformable cushion, the elastoplastic knee 20 and the elastoplastic knee-piece 30 will be synchronously subject to a deflecting pressure force. At this moment, the buffering distance 22 at a side of the elastoplastic knee 20 will be shortened after being compressed, while the buffering distance at another side will be lengthened. However, the arc-curved portions 31 of the elastoplastic knee-piece 30 also will be shortened and lengthened along with the deformation of the buffering distance 22. In this case, not only the elastoplastic knee 20 and the elastoplastic knee-pieces 30 at the compression side of the elastic deformable cushion will be synchronously subject to the deflecting press force P, but also the arc-curved portions 31 of the elastoplastic knee-piece 30 at another side of the elastic deformable cushion will assist the elastoplastic knee 20 produce a supporting force to counter the deformation. The curved portions 21 and the supporting portions 23 of the elastoplastic knee 20 can disperse the pressure force over a larger area of the elastic deformable cushion A. Through this way, not only the hard elastoplastic knee-piece 30 can effectively balance the pressure force P and protect the soft elastoplastic knee 20, but also the supporting portions 23, the arc-curved portions 31 and the curved portions 21 are able to produce a balance effect by dispersing the deflecting pressure force. Such that the abruption and dislocation of the hard elastoplastic knee-piece 30 can be effective prevented. A first preferred embodiment in accordance with the present invention is shown in FIG. 6, in which, the elastic deformable cushion in accordance with the present invention is placed into the heel of a sneaker 40 for shock-absorbing purpose.

It is to be noted that the top surface 32 and the bottom surface 33 of the elastoplastic knee-piece 30 can be formed on the top layer and the lowest layer of the elastoplastic knee 20. Furthermore, the elastoplastic knee and the top and the bottom surfaces of the elastoplastic knee-piece can be formed with curved surface corresponding to the to-be-loaded object.

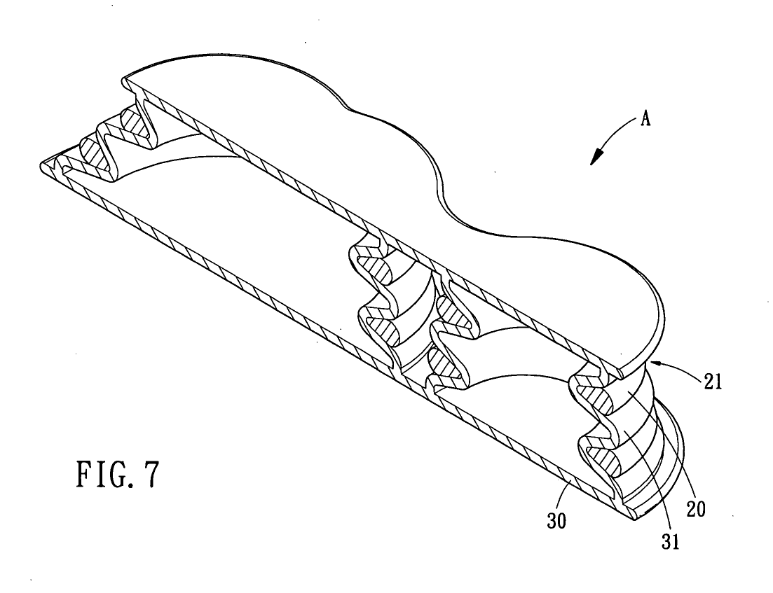

A second preferred embodiment of the present invention is shown in FIG. 7, in which, the supporting portions 23 of the elastoplastic knee 20 can be omitted, or some layers of the elastoplastic knee-piece 30 can be made of soft material so as to be combined with the corresponding layers of the elastoplastic knee 20.

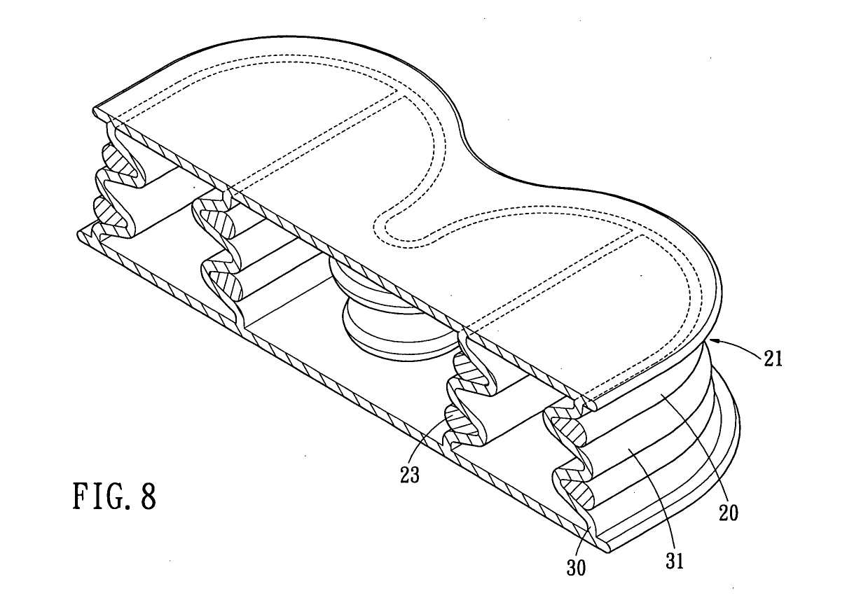

Referring to FIG. 8, which shows a third embodiment in accordance with the present invention, wherein the curvature and the angle of the curved portions 21 of the elastoplastic knee 20 can be set according to the user's needs. For example, the curved portions 21 can be U-shaped, semi-circular-shaped or elliptical-shaped.

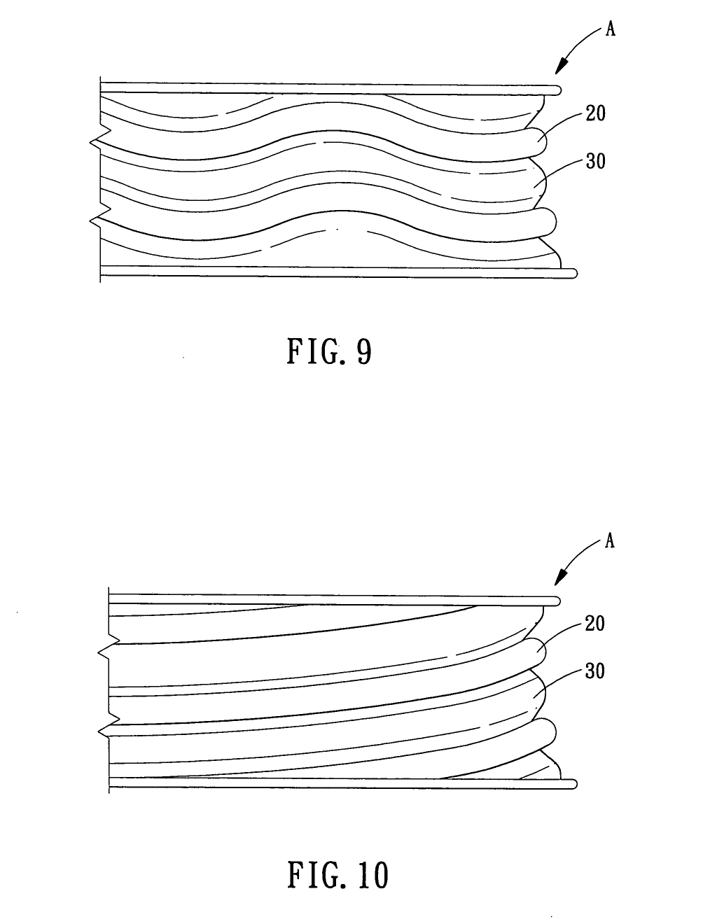

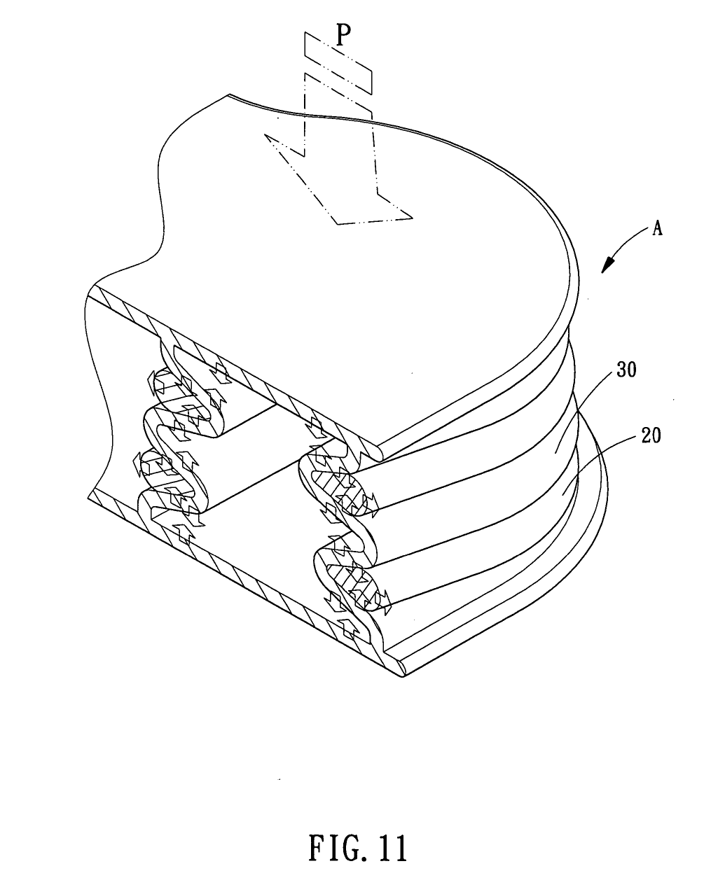

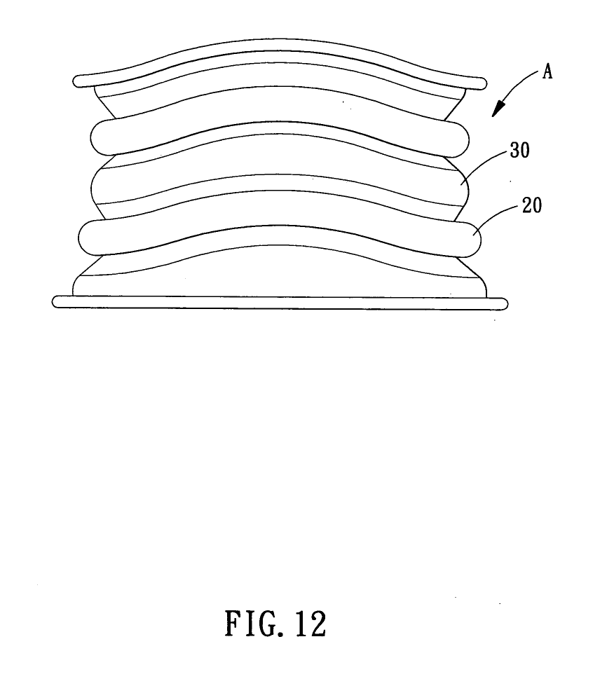

The thrust surface corresponding to the elastoplastic knee 20 is not limited to horizontal surface, it also can be wave-shaped thrust surface (as shown in FIG. 9), inclined thrust surface (as shown in FIGS. 10 and 11) or slope-shaped thrust surface (as shown in FIG. 12). Not only the curved portions 21 has a force-bearing function, but also the curve-shaped base body of the elastoplastic knee 20 can produce a strong supporting force and can effectively disperse the pressure force P.

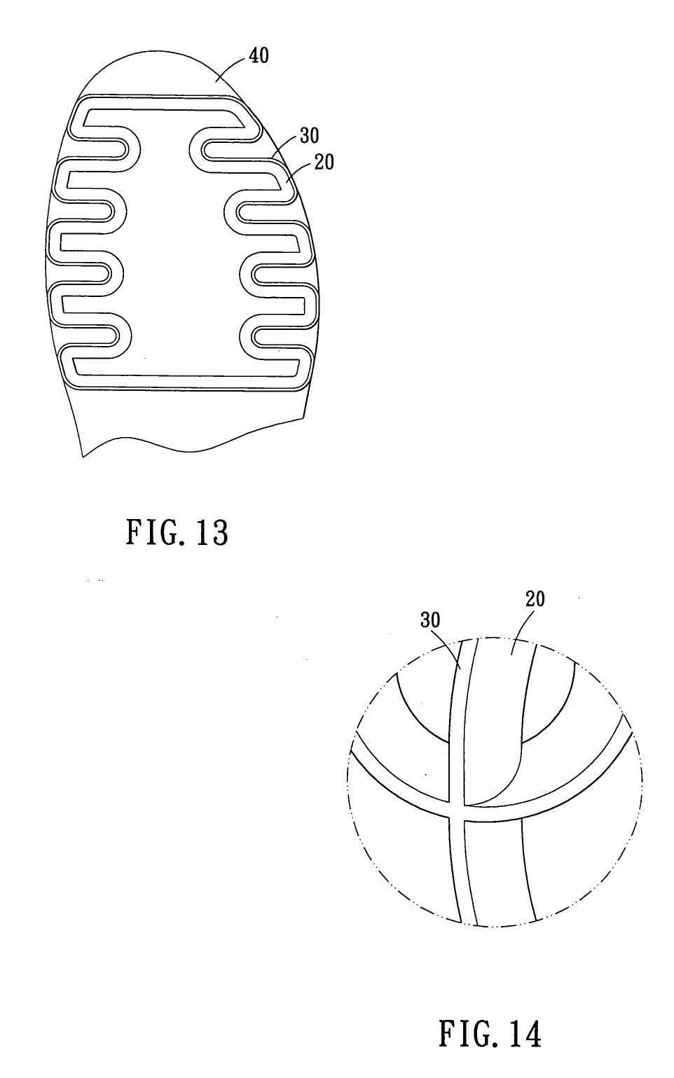

Referring to FIG. 13, the elastic cushion also can be placed in front portion of the sole of the sneaker 40. As shown in FIG. 14, the elastoplastic knee 20 and the elastoplastic knee-piece 30 can be crosswise arranged.

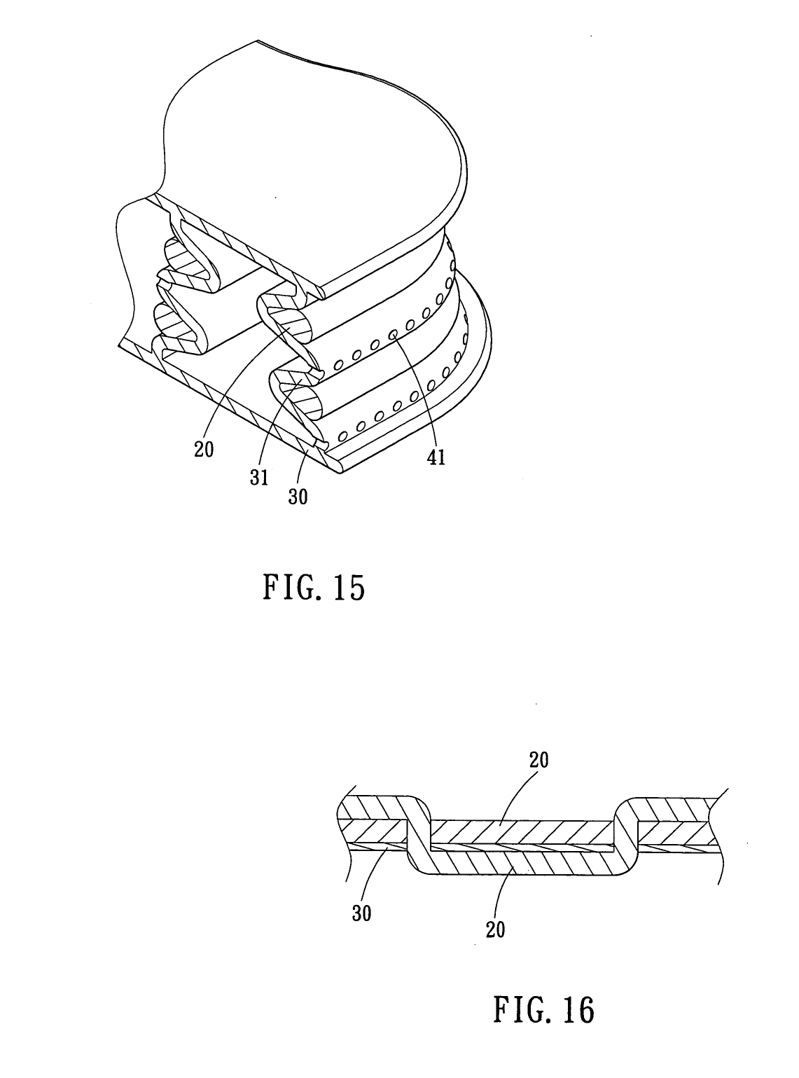

Referring to FIG. 15, the elastoplastic knee 20 and the elastoplastic knee-piece 30 in accordance with the present invention can be formed with holes 41 or grooves, so as not only to reduce the weight but also to adjust the damper effect of the elastic cushion.

As shown in FIG. 16, the plural elastoplastic knee 20 can be interlaced with each other, so as to improve the structural strength of the elastic cushion.

While we have shown and described various embodiments in accordance with the present invention, it should be clear to those skilled in the art that further embodiments may be made without departing from the scope of the present invention.

What is claimed is:

1. An elastic deformable cushion including:
an elastoplastic knee made of elastoplastic material and provided with curved portions corresponding to thrust surface;
an elastoplastic knee-piece made of elastoplastic material, which is formed at a position perpendicular to the elastoplastic knee-piece with plural layers of arc-curved portions, the elastoplastic knee-piece integrally formed with the plural elastoplastic knee, the arc-curved portions of the elastoplastic knee-piece located beside the elastoplastic knee corresponding to thrust direction.

2. The elastic deformable cushion as claimed in claim 1, wherein a thrust surface is respectively formed at a top surface and a bottom surface of the elastoplastic knee.

3. The elastic deformable cushion as claimed in claim 1, wherein a thrust surface is respectively formed at a top surface and a bottom surface of the elastoplastic knee piece.

4. The elastic deformable cushion as claimed in claim 1, wherein the elastoplastic knee is multi-layer constructed, so as to disperse pressure force layer by layer, and the respective layers of the elastoplastic knee are alternatively arranged corresponding to the thrust direction.

5. The elastic deformable cushion as claimed in claim 4, wherein the respective layers of the elastoplastic knee are separated from each other by a buffering distance, the respective arc-curved portions of the elastoplastic knee piece are continuously formed and located in the buffering distance between the respective layers of the elastoplastic knee.

6. The elastic deformable cushion as claimed in claim 1, wherein the elastoplastic knee is provide at the curved portions with an outward protruded supporting portion.

7. The elastic deformable cushion as claimed in claim 4, wherein the elastoplastic knee is provide at the curved portions with an outward protruded supporting portion.

8. The elastic deformable cushion as claimed in claim 1, wherein thrust surface of the elastoplastic knee is a wave-shaped thrust surface.

9. The elastic deformable cushion as claimed in claim 4, wherein thrust surface of the elastoplastic knee is a wave-shaped thrust surface.

10. The elastic deformable cushion as claimed in claim 1, wherein thrust surface of the elastoplastic knee is an incline-shaped thrust surface.

11. The elastic deformable cushion as claimed in claim 1, wherein thrust surface of the elastoplastic knee is a slope-shaped thrust surface.

12. The elastic deformable cushion as claimed in claim 4, wherein thrust surface of the elastoplastic knee is a slope-shaped thrust surface.

13. The elastic deformable cushion as claimed in claim 1, wherein the elastic deformable cushion is placed into a heel of a sneaker.

14. The elastic deformable cushion as claimed in claim 4, wherein the elastic deformable cushion is placed into a heel of a sneaker.

15. The elastic deformable cushion as claimed in claim 1, wherein the elastoplastic knee is formed with grooves and holes in order to reduce weight, adjust shock-absorbing effect and improve breathability of the elastic deformable cushion.

16. The elastic deformable cushion as claimed in claims 4, wherein the elastoplastic knee is formed with grooves and holes in order to reduce weight, adjust shock-absorbing effect and improve breathability of the elastic deformable cushion.

17. The elastic deformable cushion as claimed in claim 1, wherein the elastoplastic knee piece is formed with grooves and holes in order to reduce weight, adjust shock-absorbing effect and improve breathability of the elastic deformable cushion.

18. The elastic deformable cushion as claimed in claim 4, wherein the elastoplastic knee piece is formed with grooves and holes in order to reduce weight, adjust shock-absorbing effect and improve breathability of the elastic deformable cushion.

19. The elastic deformable cushion as claimed in claim 1, wherein the respective layers of the elastoplastic knee are interlaced with each other, so as to form a woven-like structure.

20. The elastic deformable cushion as claimed in claim 4, wherein the respective layers of the elastoplastic knee are interlaced with each other, so as to form a woven-like structure.
